(19) United States
(12) Patent Application Publication
(10) Pub. No.: US 2008/0010299 A1
(43) Pub. Date: Jan. 10, 2008

(54) FILE MANAGEMENT SYSTEM

(75) Inventor: Jun Ogawa, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/851,516

(22) Filed: Sep. 7, 2007

Related U.S. Application Data
(63) Continuation of application No. PCT/JP2005/004983, filed on Mar. 18, 2005.

(51) Int. Cl. G06F 17/30

(52) U.S. Cl. 707/10

(57) ABSTRACT

A file management system characterized in that at least one of the nodes included in a peer-to-peer network is provided with a database storing updateable files and a distribution history list preparation unit for preparing a distribution history list storing distribution destination nodes of files stored in the database, a file management method, a file management program, and a file management program storage medium are provided.

### CROSS-REFERENCE TO RELATED APPLICATIONS

This application is based upon International Patent Application PCT/JP2005/004983, filed Mar. 18, 2005, the contents being incorporated herein by reference.

### TECHNICAL FIELD

The present invention relates to a file management system in a peer-to-peer network (P2P), more particularly relates to a file management system storing a file distribution destination node at the distribution originator of an updateable file and distributing an updated file to the distribution destination whenever the file is updated.

### BACKGROUND ART

In the past, a peer-to-peer (P2P) type network realizing file sharing between end nodes without going through any specific server has attracted attention. In a P2P type network, a copy file at a certain note in that network is further copied at another node to realize file sharing having scalability. In the conventional P2P communication, file sharing between end nodes is realized by the following two functions.

1) File search function: Function enabling search of which nodes have a file. There are roughly two methods of realization.
(a) Center server type: System where center server has attribute information of the file (file name, timestamp, etc.) and a list of nodes having that file and where the end node searches for this.
(b) Pure-P2P type: System flooding a search message between nodes of P2P and searching for nodes having the file.

2) Download function of file: Function of establishing session with nodes obtained by the file search and transferring the file.

The present invention covers the above-described pure P2P type, therefore below an example of that operation will be explained. Note that, in P2P, at the present time, there is no standardized technology either for the pure P2P type or the center server type, therefore here a representative application software of the pure P2P type, that is, Gnutella®, is shown as prior art.

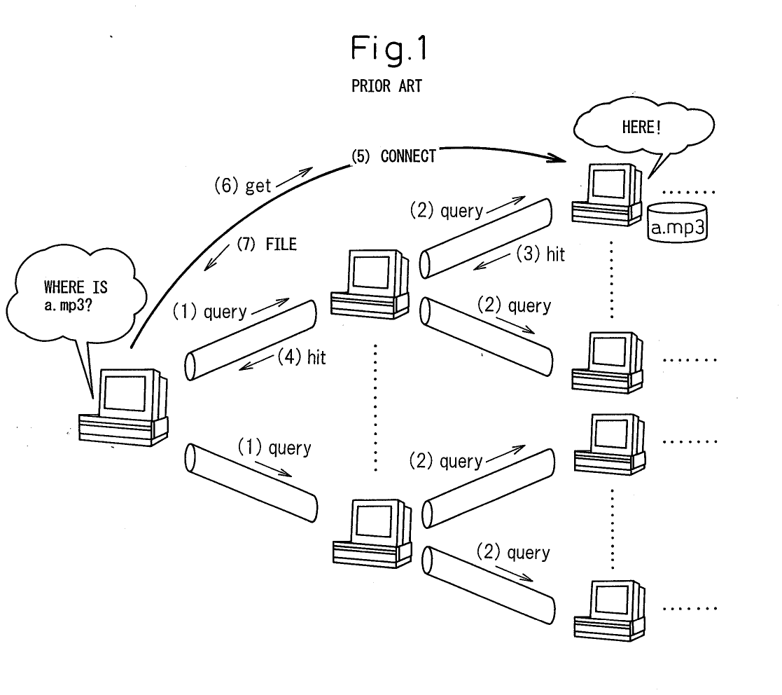

FIG. 1 is a schematic view explaining the conventional Gnutella.

Summary of Gnutella®

Gnutella® is an application software for exchange of files between individuals through the Internet. Gnutella® users are connected to each other through the Internet and publish lists of files sharable with other users from among owned files. When searching for a file on Gnutella®, files matching with conditions are extracted from among the files published by nodes other than the home node. The node searching for the file can directly download a resource from a node having the resource.

File Search Routine in Gnutella®

Below, a file search routine in Gnutella® will be described.

(Features of Routine)

In FIG. 1, when a file discovery request query is sent to a connected host, the request is sequentially relayed between adjacent nodes. Discovery of the file is realized by the host having the file under request returns a hit response.

(Routine)

(1) A file query command is transmitted to the adjacent node.

(2) This command is sequentially relayed.

(3) Nodes having the file return hit responses.

(4) The hit responses are returned to the node of the distribution originator of the query sequentially following a route inverse to the query.

(5) One of the nodes returning the hit response is connected with by TCP.

(6) A file get request is transmitted.

(7) The file content is sent back.

Note that in (2) described above, in order to prevent the query from ending up being infinitely relayed, there is concept of TTL (Time To Live) in the same way as the IP (Internet Protocol). Queries transferred to more than a certain number of nodes are discarded.

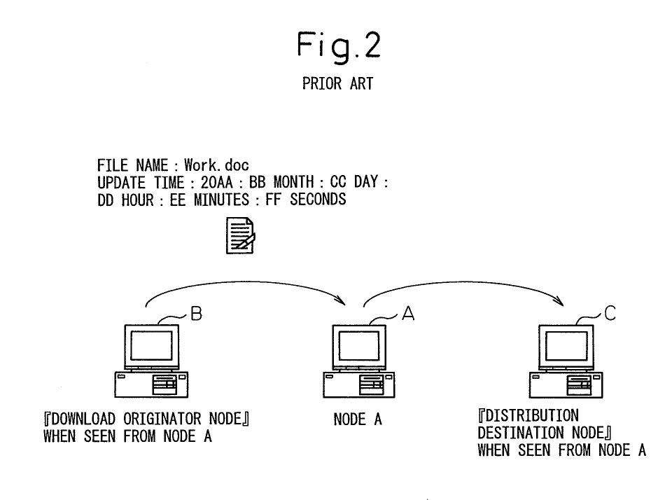

FIG. 2 is a diagram explaining the state of distribution of files in a conventional pure P2P network. In the illustrated example, a file having the file name “Work.doc” and updated at a timing of 20AA year: BB month: CC day: DD hour: EE minutes: and FF seconds is distributed from a download originator node B to a node C through a node A when seen from the node A. The node C is the distribution destination node when seen from the node A.

### DISCLOSURE OF THE INVENTION

### PROBLEM TO BE SOLVED BY THE INVENTION

In the above-described prior art, communication is started triggered by the file search by the node desiring download. This is because the prior art covers the exchange of music files and other files predicated on never being updated. For this reason, when downloading a file prepared by Word®, Excel®, or the like which are updated, there was a problem that the distribution destination node could not immediately determine if the file had been updated after having been downloaded.

For this reason, in the prior art, when a file was updated at the node preparing the file, in order to detect updating at another node (node having a copy of that file), there was a problem of the troublesome work of checking for any updating by repeatedly searching for the file. This is because, as described above, the communication was triggered by a file search by a node desiring the download.

An object of the present invention is to immediately transmit an updated file to a distribution destination node when a file has been updated in the case of file exchange in a P2P framework.

To attain this object, according to a first aspect of the present invention, there is provided a file management system characterized in that at least one of the nodes included in a peer-to-peer type network is provided with a database storing updateable files and a distribution history list preparing means for preparing a distribution history list storing distribution destination nodes of files stored in the database.

Due to this, at least one node among the nodes included in the peer-to-peer type network holds a distribution history list of distribution destination nodes of an updated file, therefore an updated file can be immediately distributed to the distribution destination, and it becomes possible for the distribution destination node to constantly obtain the newest file even when the file is updated at the distribution originator node.

According to a second aspect of the present invention, in said file management system, at least one node is provided with a file re-distributing means for distributing an updated file to the distribution destination nodes registered in the distribution history list in a predetermined time from the updating when a file is updated.

Due to this, an updated file is reliably distributed to the distribution destination node.

According to a third aspect of the present invention, in said file management system, all nodes included in the peer-to-peer type network are provided with distribution history list preparing means and file re-distributing means.

Due to this, in all nodes included in the peer-to-peer type network, an updated file is reliably distributed to the distribution destination node.

According to a fourth aspect of the present invention, in said file management system, provision is made of a distribution history list entrusting means for entrusting a distribution history list to a representative node included in the peer-to-peer type network different from the distribution originator node in a case where the distribution originator node of the file leaves the peer-to-peer type network,

Due to this, even in the case where the file distribution originator node leaves the network due to shutdown etc., the distribution history list can be entrusted to the representative node, therefore the updated file will never become unavailable.

According to a fifth aspect of the present invention, in said file management system, the representative node is provided with a file returning means for returning the distribution history list from the representative node to the returning node in a case where a node leaving the peer-to-peer type network returns to the peer-to-peer type network.

Due to this, it becomes possible to distribute an updated file to the distribution destination node by the returning node in the case where a node leaving the peer-to-peer type network returns to the peer-to-peer type network.

According to the present invention, there is also provided a method for realizing said file management system, a program for making a computer execute the operation of said file management system, and a storage medium storing that program.

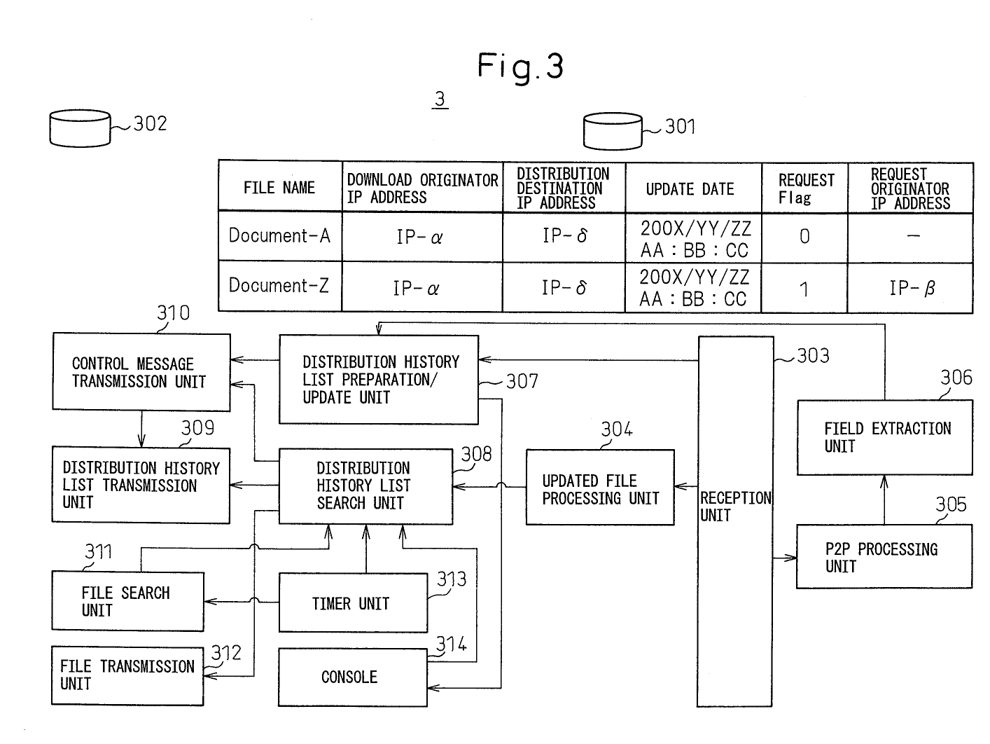

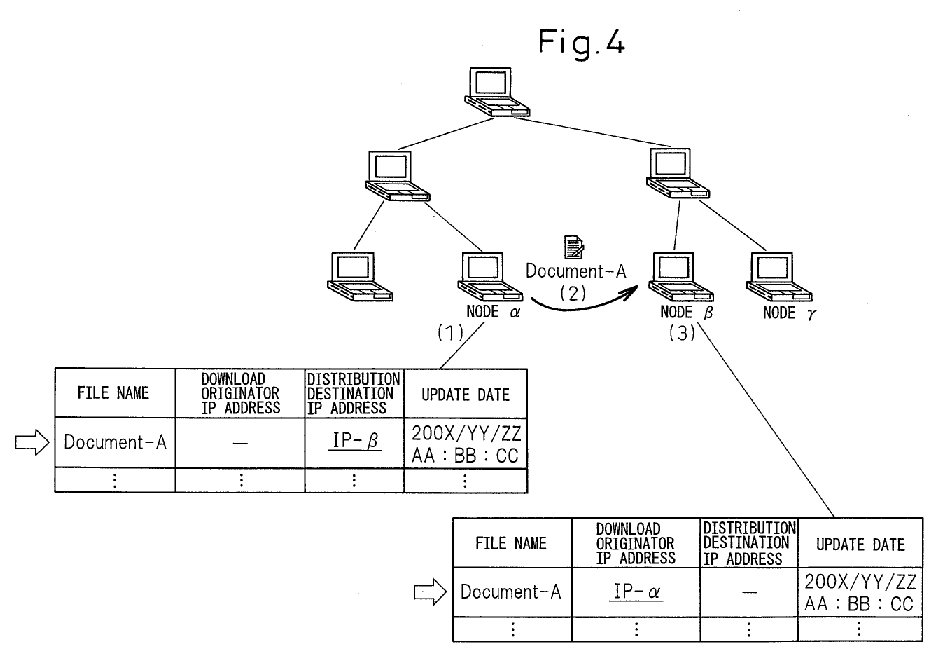

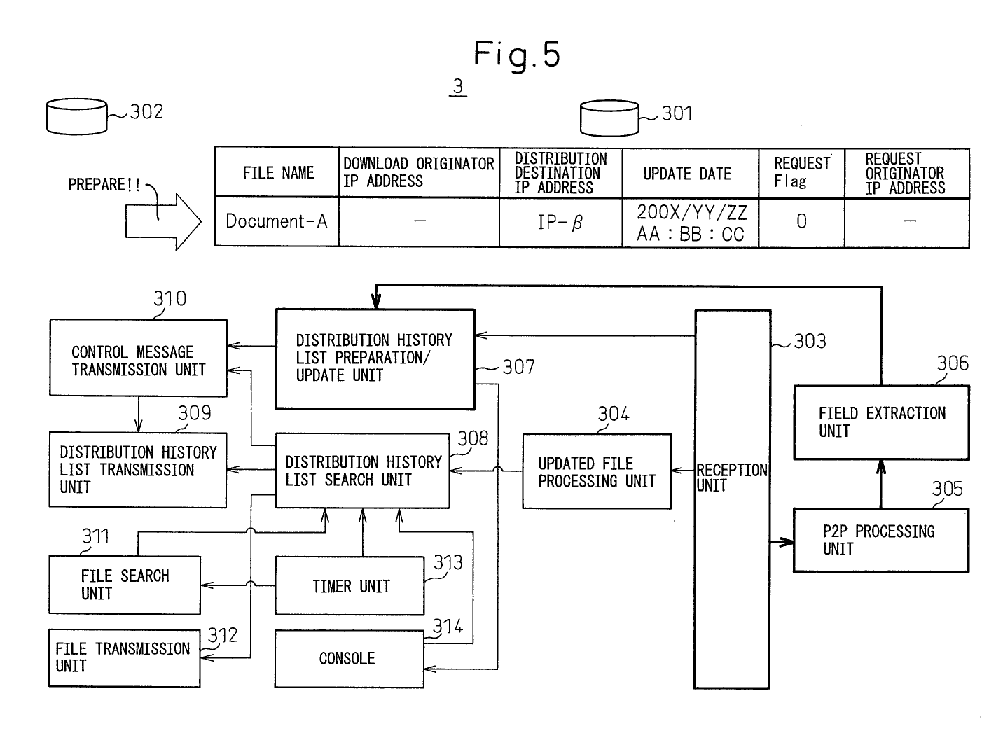

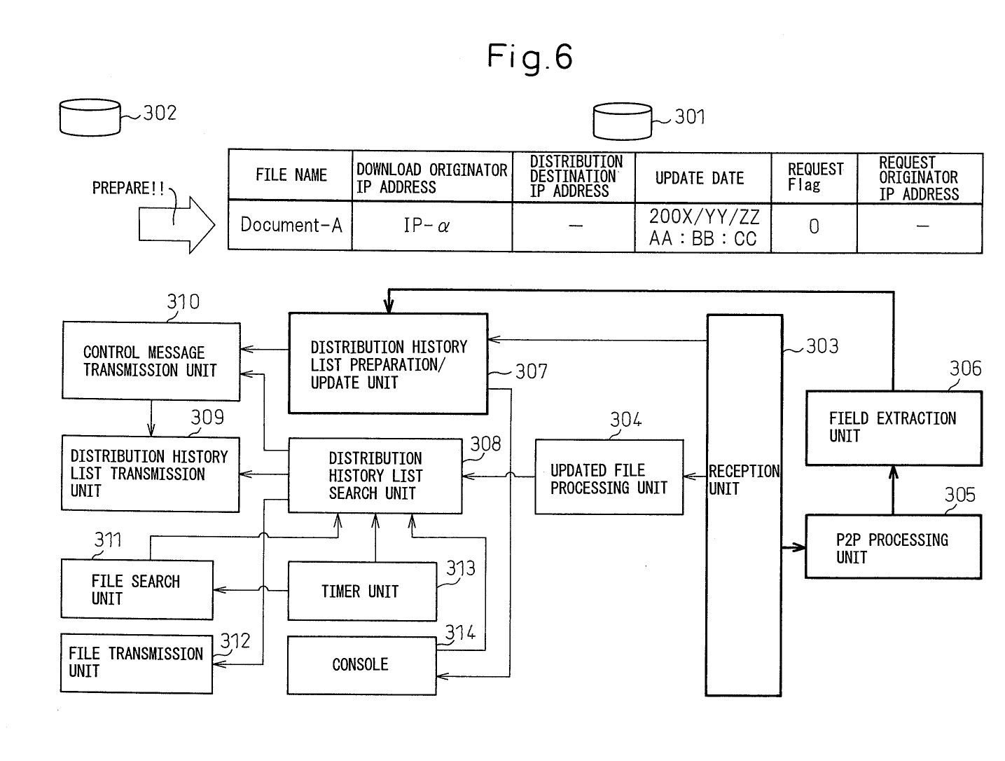

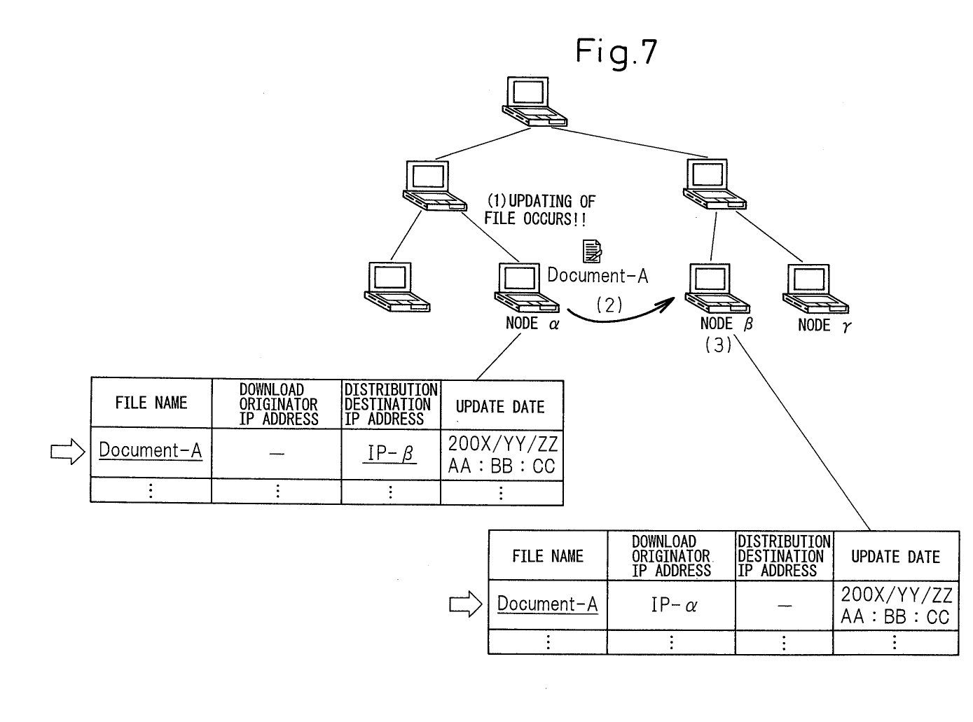

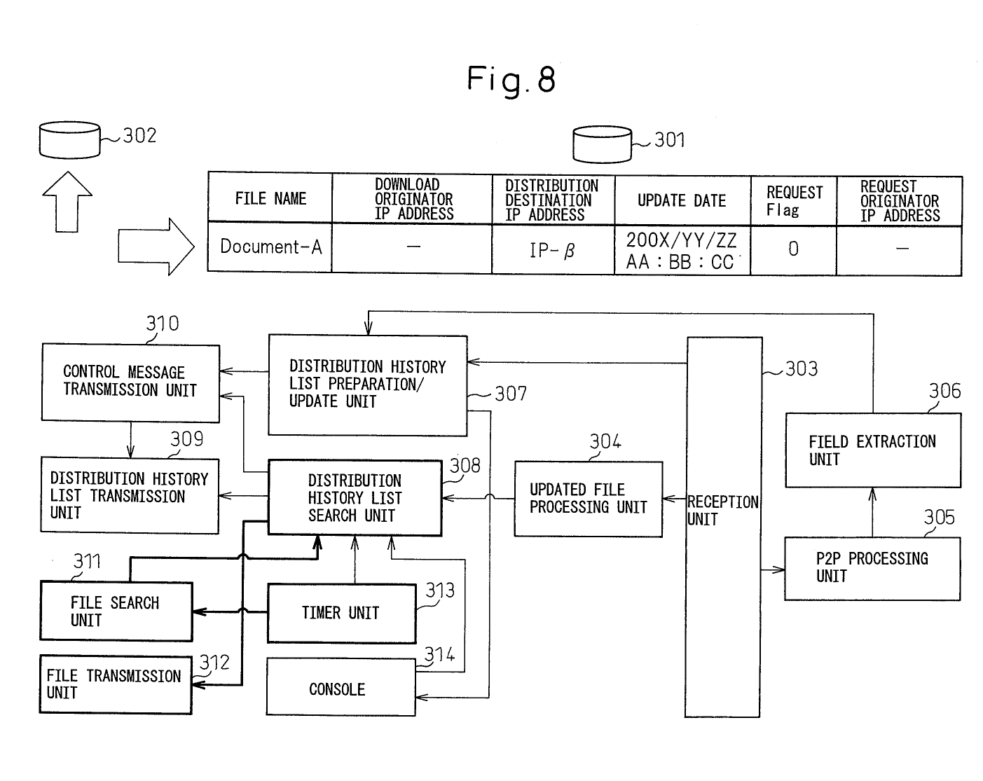

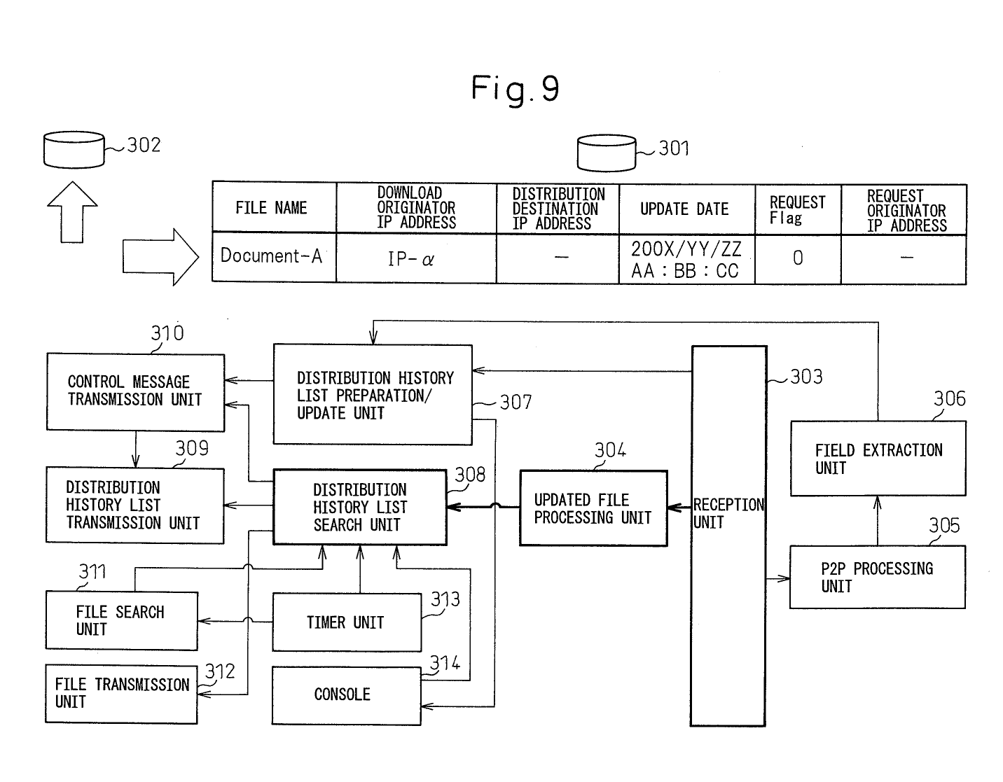

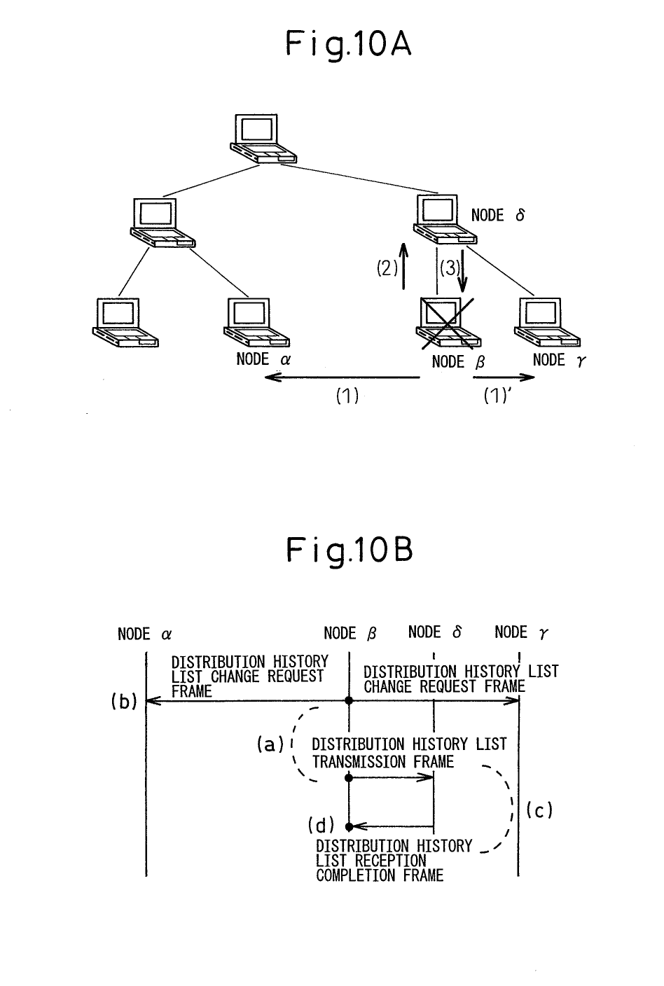

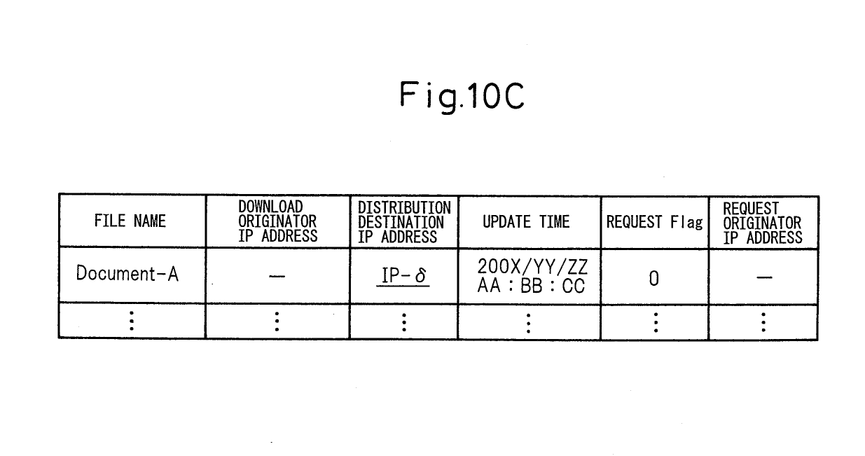

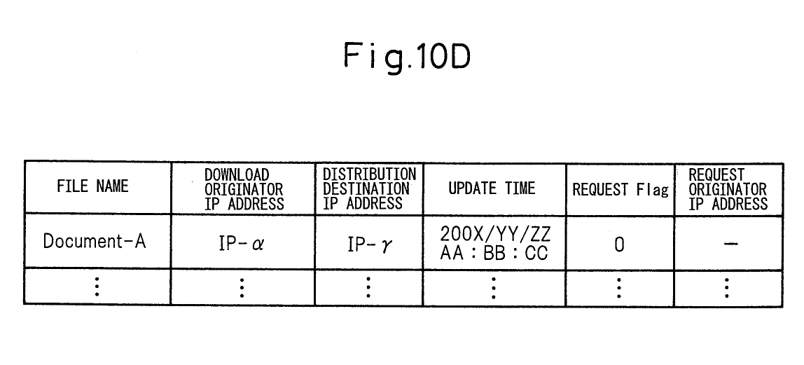

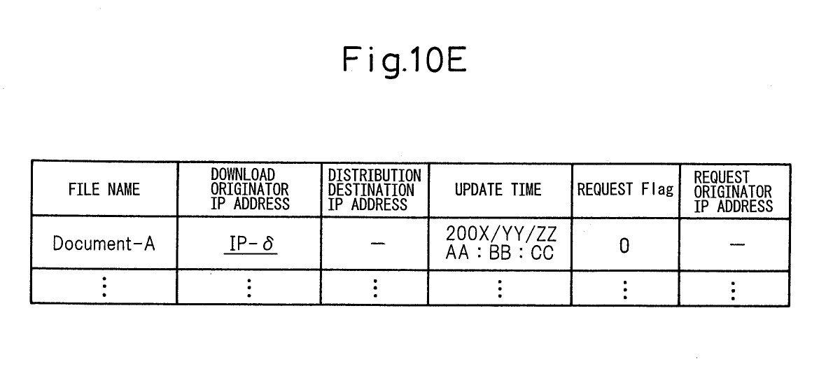

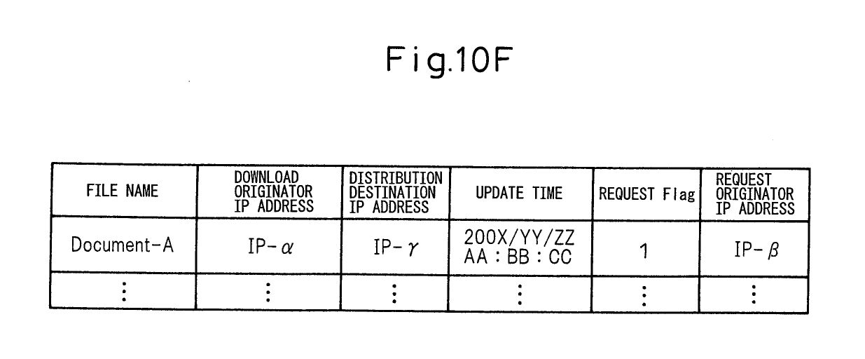

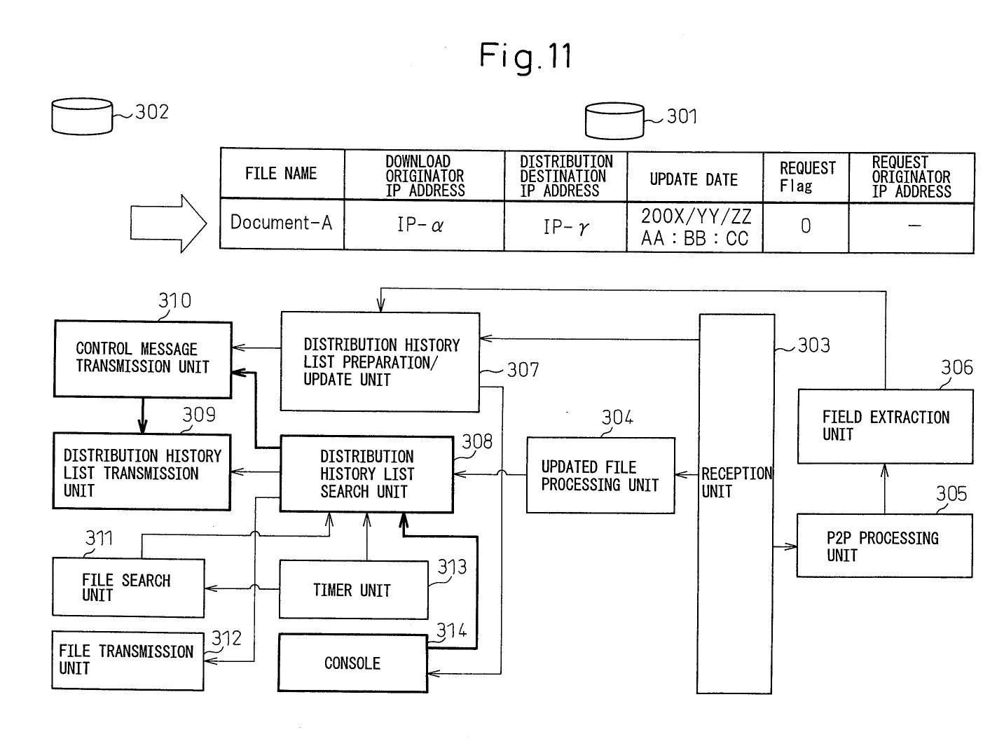

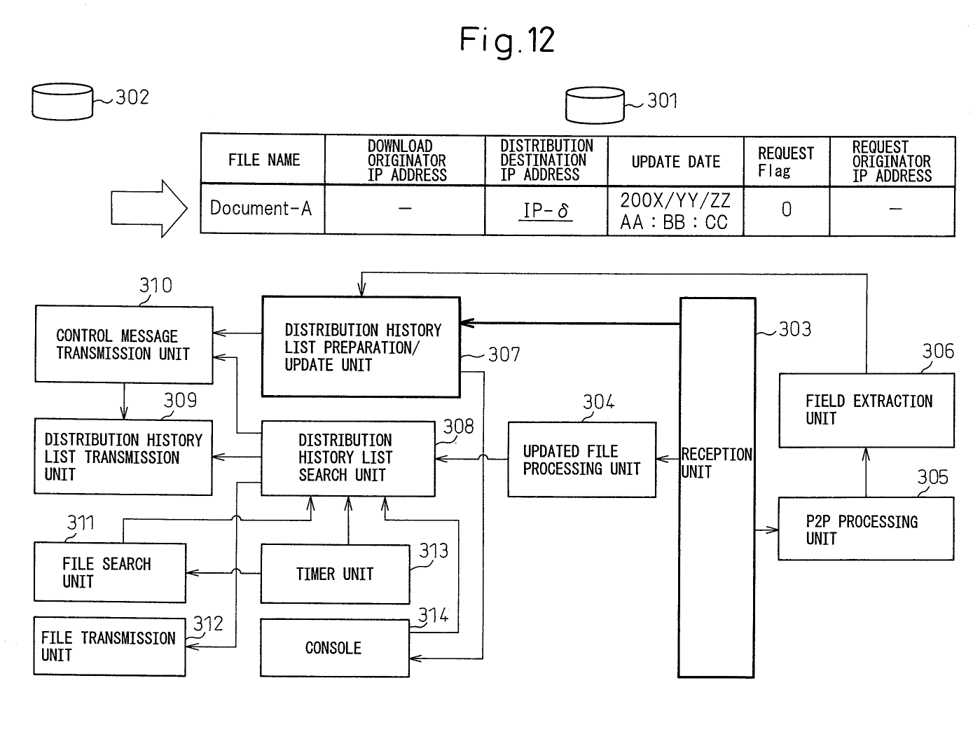

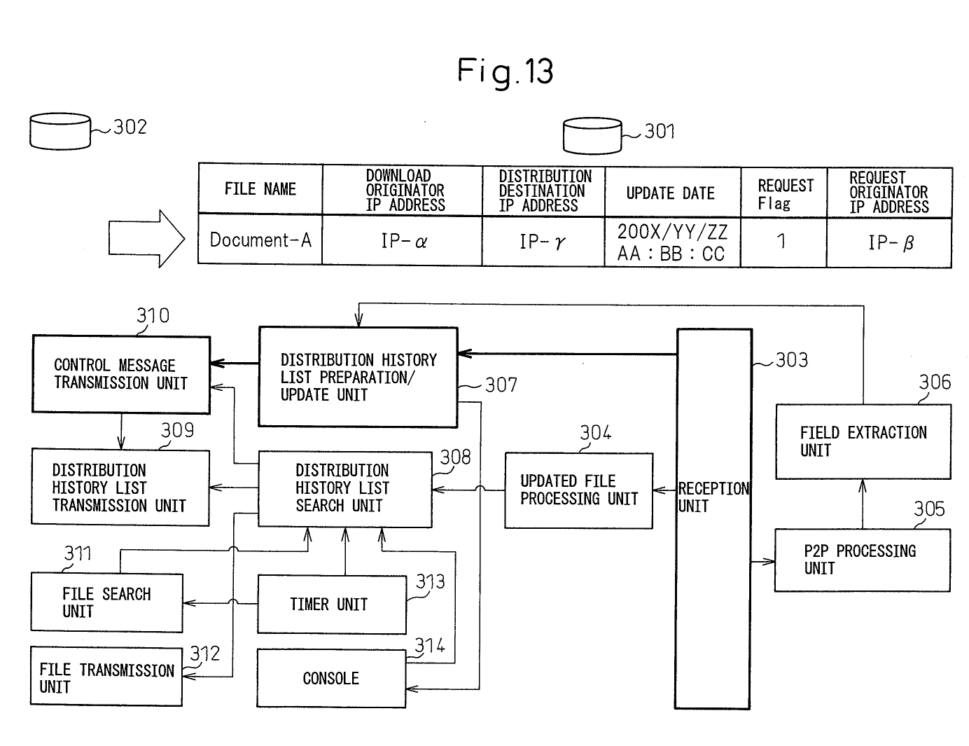

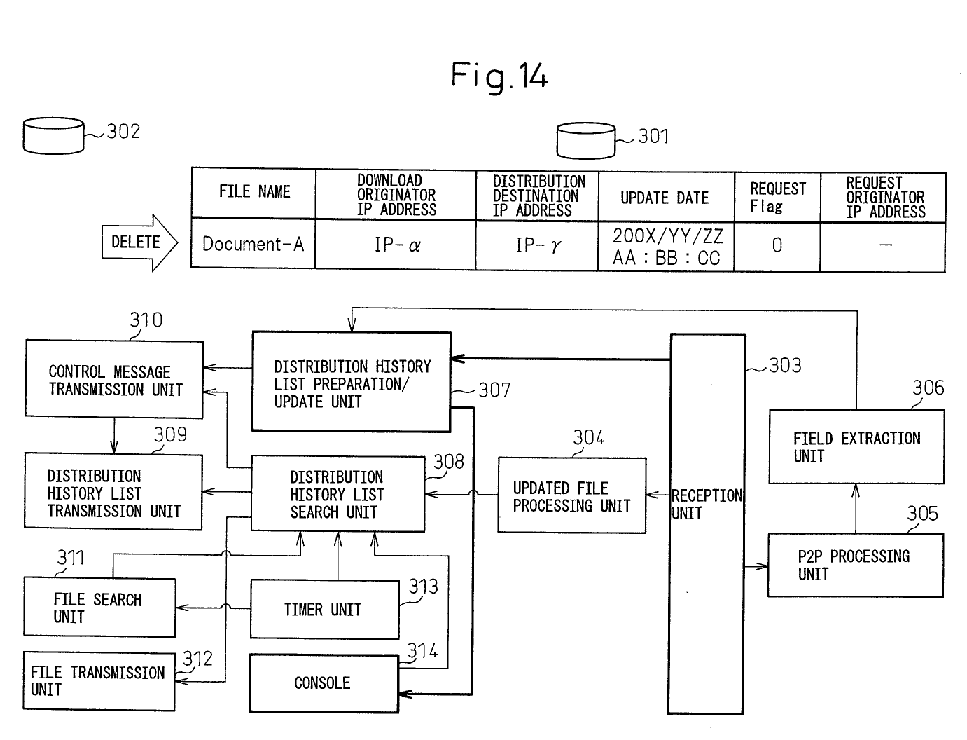

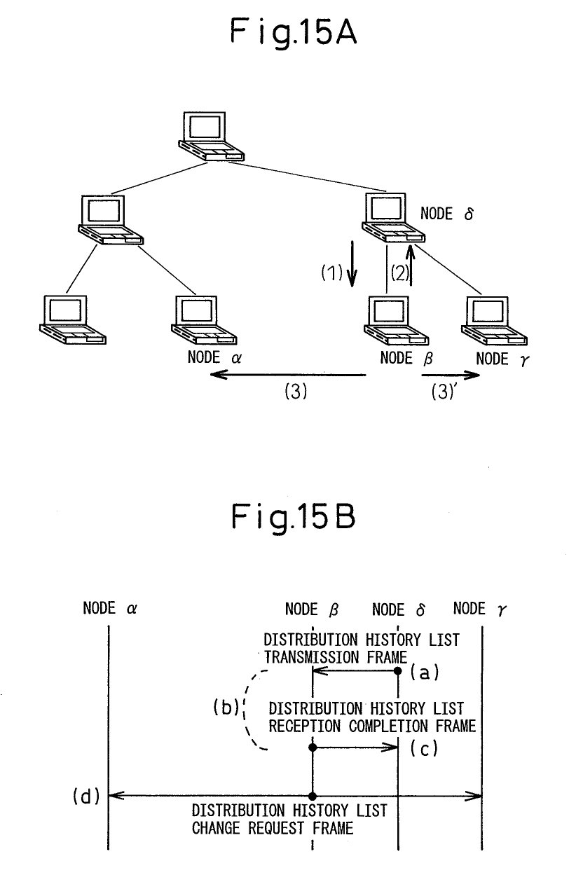

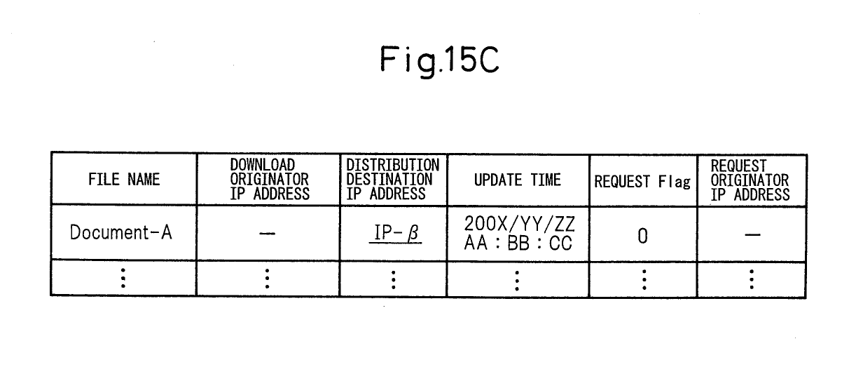

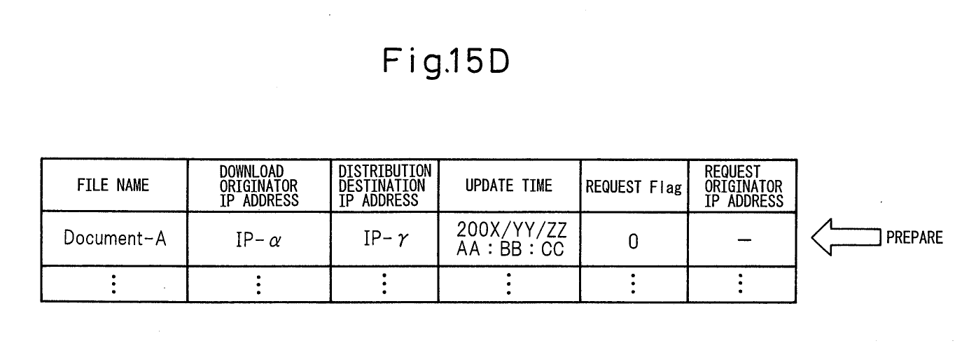

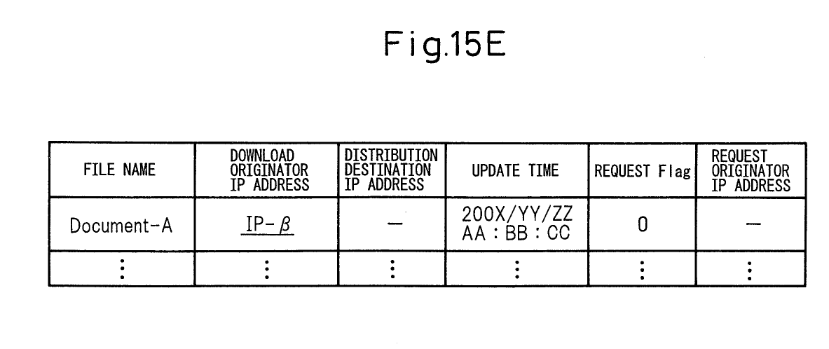

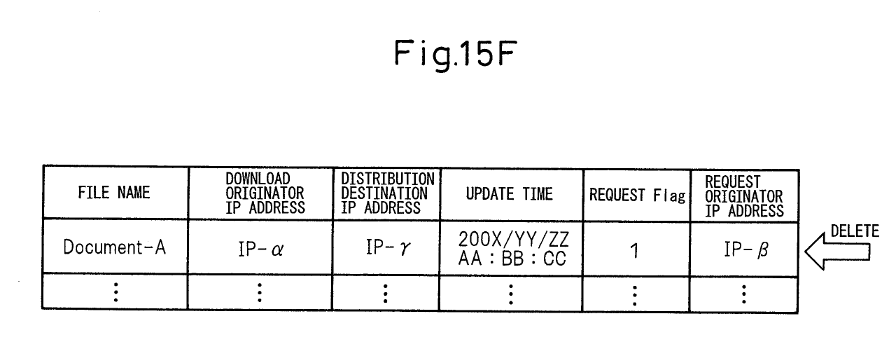

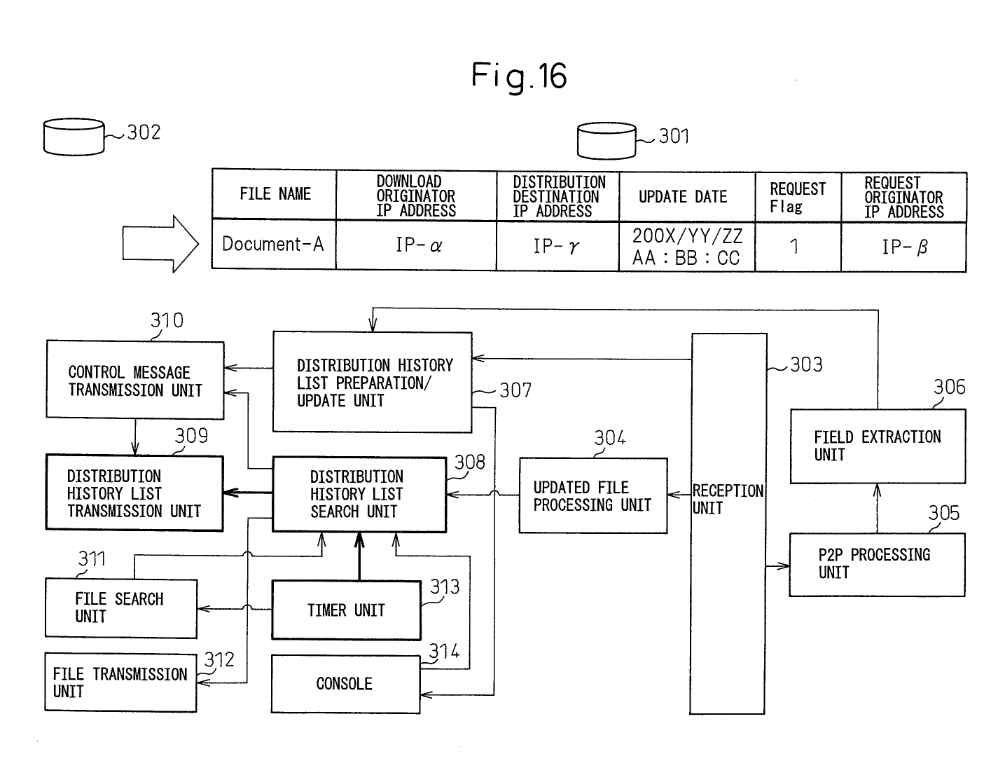

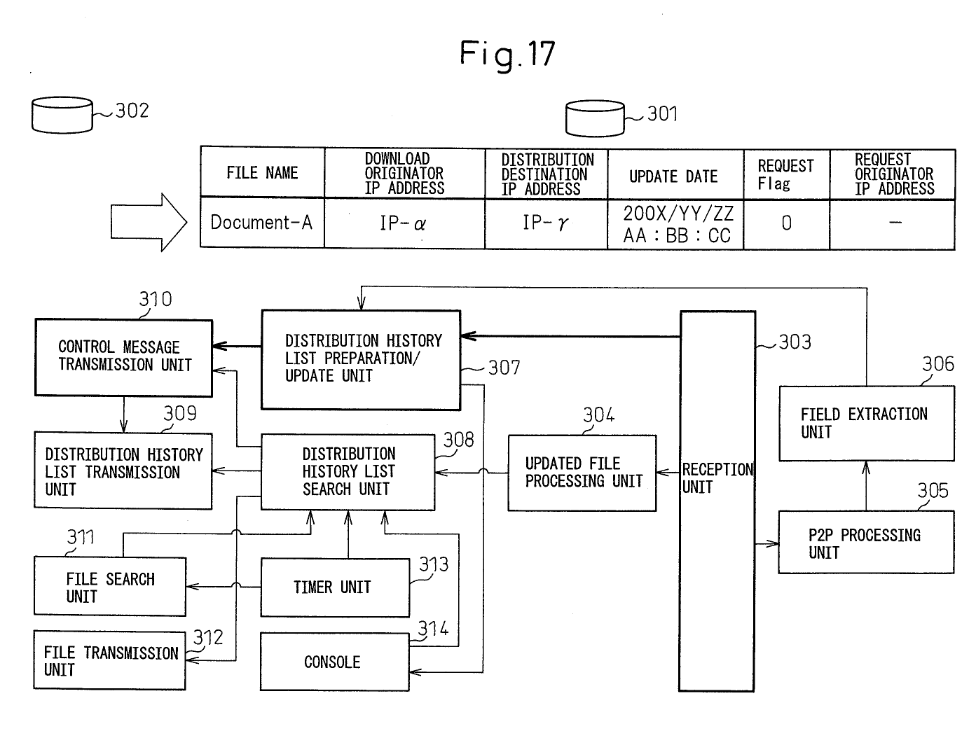

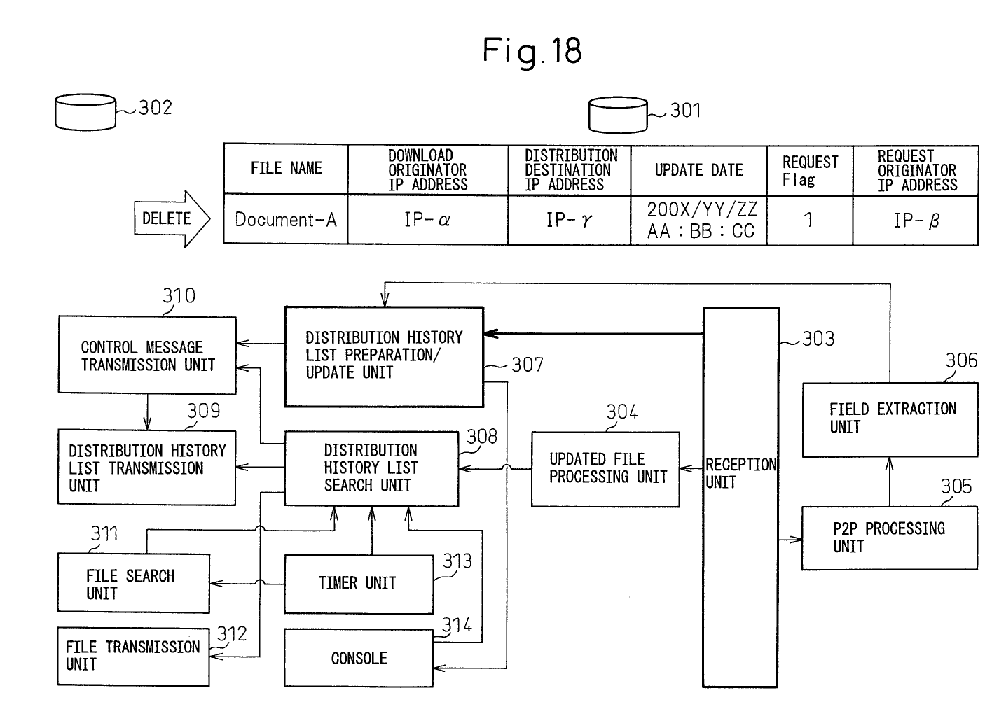

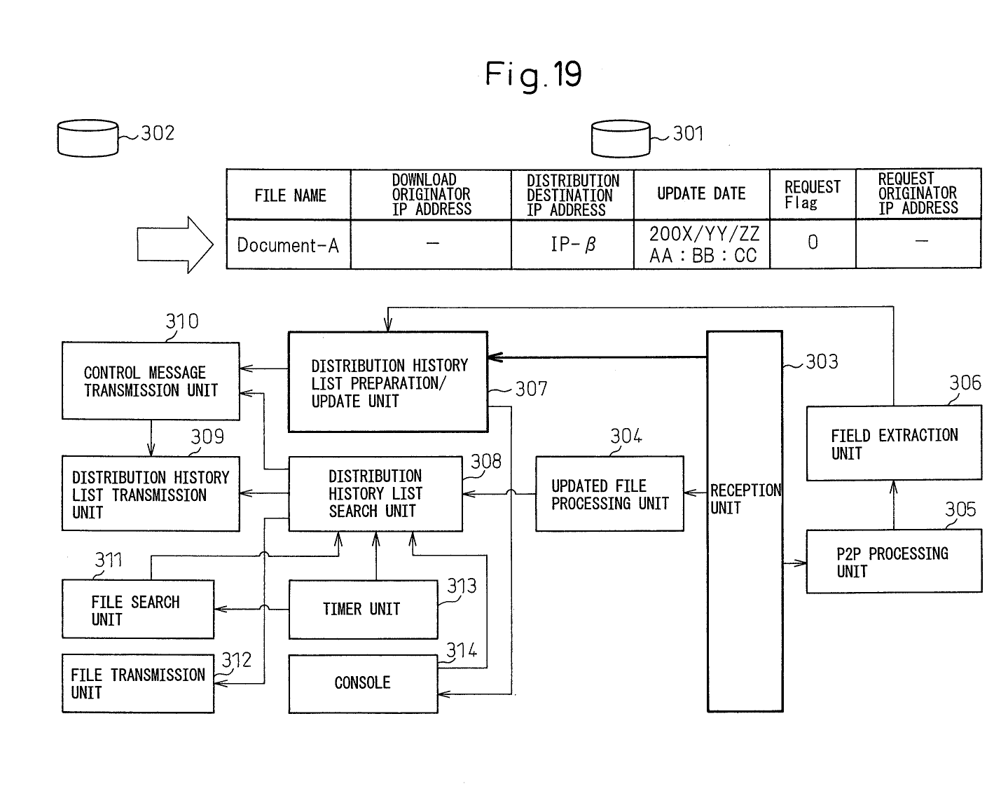

### BRIEF DESCRIPTION OF THE DRAWINGS

[FIG. 1] A schematic diagram explaining the conventional Gnutella®.

[FIG. 2] A diagram explaining a state of distribution of a file in a conventional pure P2P network.

[FIG. 3] A block diagram showing the configuration of a relay node according to an embodiment of the present invention.

[FIG. 4] A diagram explaining the overall flow of processing for dynamically preparing a distribution route of a file according to an embodiment of the present invention.

[FIG. 5] A diagram explaining the flow of processing at a distribution destination node α according to an embodiment of the present invention.

[FIG. 6] A diagram explaining the flow of processing at a distribution originator node β according to an embodiment of the present invention.

[FIG. 7] A diagram explaining the overall flow of processing at the time of updating a file according to an embodiment of the present invention.

[FIG. 8] A diagram explaining the flow of processing at a distribution destination node α at the time of updating a file according to an embodiment of the present invention.

[FIG. 9] A diagram explaining the flow of processing at a distribution destination node β at the time of updating a file according to an embodiment of the present invention.

[FIG. 10A] A diagram explaining the overall flow of processing at the time of a request for management of a distribution history list database according to an embodiment of the present invention.

[FIG. 10B] A time sequence diagram showing the flow of processing at the time of request for management of a distribution history list database according to an embodiment of the present invention.

[FIG. 10C] A diagram showing a distribution history list of a node α at the time of a request for management of a distribution history list database according to an embodiment of the present invention.

[FIG. 10D] A diagram showing a distribution history list of a node β at the time of a request for management of a distribution history list database according to an embodiment of the present invention.

[FIG. 10E] A diagram showing a distribution history list of a node δ at the time of a request for management of a distribution history list database according to an embodiment of the present invention.

[FIG. 10F] A diagram showing a distribution history list of a node δ at the time of a request for management of a distribution history list database according to an embodiment of the present invention.

[FIG. 11] A diagram explaining the flow of processing in (a) of FIG. 10B at a distribution destination node β at the time of a request for management of a distribution history list database according to an embodiment of the present invention.

[FIG. 12] A diagram explaining the flow of processing in (b) of FIG. 10B at a distribution destination node α at the time of a request for management of a distribution history list database according to an embodiment of the present invention.

[FIG. 13] A diagram explaining the flow of processing in (c) of FIG. 10B at a distribution destination node δ at the time of a request for management of a distribution history list database according to an embodiment of the present invention.

[FIG. 14] A diagram explaining the flow of processing in (d) of FIG. 10B at a distribution destination node β at the time of a request for management of a distribution history list database according to an embodiment of the present invention.

[FIG. 15A] A diagram explaining the overall flow of processing at the time of a request for returning a distribution history list database according to an embodiment of the present invention.

[FIG. 15B] A time sequence diagram showing the flow of processing at the time of a request for returning a distribution history list database according to an embodiment of the present invention.

[FIG. 15C] A diagram showing a distribution history list of the node α at the time of a request for returning a distribution history list database according to an embodiment of the present invention.

[FIG. 15D] A diagram showing a distribution history list of the node β at the time of a request for returning a distribution history list database according to an embodiment of the present invention.

[FIG. 15E] A diagram showing a distribution history list of the node γ at the time of a request for returning a distribution history list database according to an embodiment of the present invention.

[FIG. 15F] A diagram showing a distribution history list of the node δ at the time of a request for returning a distribution history list database according to an embodiment of the present invention.

[FIG. 16] A diagram explaining the flow of processing in (a) of FIG. 15B at the distribution destination node δ at the time of a request for returning a distribution history list database according to an embodiment of the present invention.

[FIG. 17] A diagram explaining the flow of processing in (b) of FIG. 15B at the distribution destination node β at the time of a request for returning a distribution history list database according to an embodiment of the present invention.

[FIG. 18] A diagram explaining the flow of processing in (c) of FIG. 15B at the distribution destination node δ at the time of a request for returning a distribution history list database according to an embodiment of the present invention.

[FIG. 19] A diagram explaining the flow of processing in (d) of FIG. 15B at the distribution destination node α at the time of a request for returning a distribution history list database according to an embodiment of the present invention.

### BEST MODE FOR CARRYING OUT THE INVENTION

FIG. 3 is a functional block diagram showing the configuration of a relay node in a P2P network according to an embodiment of the present invention. In the figure, a node 3 is provided with a distribution history list database 301, file database 302, reception unit 303, updated file processing unit 304, P2P processing unit 305, field extraction unit 306, distribution history list preparation/update unit 307, distribution history list search unit 308, distribution history list transmission unit 309, control message transmission unit 310, file search unit 311, file transmission unit 312, timer unit 313, console unit 314, and returned distribution history list search unit.

The distribution history list search unit 308 includes the returned distribution history list search unit as well. The distribution history list transmission unit 309 includes the returned distribution history list transmission unit as well.

The distribution history list database 301 is a database for managing the distribution history list and stores the following information as shown by the table in the figure.

(1) File name: File name of the file downloaded to home node or downloaded from home node through the P2P network.

(2) Download originator IP address: IP address of the download originator node of the file having the above “file name”. In a case where the node having the present database is the distribution originator of preparation of the file, there is no node corresponding to the download originator, therefore the present entry becomes “NULL” (indicated as “-” in the figure).

(3) Distribution destination IP address: IP address of the distribution destination node of the file having the above “file name”. In a case where the file is downloaded to a plurality of nodes from the node having the present database, a plurality of IP addresses are described in the present entry. Note that when a file is not downloaded from the present node, the present entry becomes “NULL” (indicated as “-” in the figure).

(4) Update date: Date when the file described in the above-described “file name” field is prepared or updated.

(5) Request flag: Indicates the entry of the distribution history list which is requested from the other node and held. The content “0” indicates the entry prepared in the home node, and the content “1” indicates an entry prepared in another node. The entry of the next “request originator IP address” is described together.

(6) Request originator IP address: When the present entry is prepared according to a request from another node, the IP address of that request originator node is described.

The file database 302 is a database for managing files and a so-called OS file system.

The reception unit 303 electrically receives communication from the network, discriminates the type of the received frames, and determines the flow of processing inside (group of functional blocks gone through).

The updated file processing unit 304 writes a file into the file database 302 at the time of reception of an updated file from the upstream node. Note that, the writing method depends upon the mounting, for example unconditional overwriting of the old file or overwriting the file after inquiry to the user, and is not particularly limited.

The P2P processing unit 305 performs the following processing which generally becomes necessary in a so-called P2P.

(1) File search processing: In P2P, processing for a file search in response to a search request of a file, processing for forwarding that request (when there is no file covered by the search target in the home node), and processing for notification of the file search results (when there is a file covered by the search in the home node) are carried out.

(2) File transmission/reception processing: Processing for transmission/reception of the file at the time of file transfer is carried out.

The field extraction unit 396 extracts the information of the field required for preparing the distribution history list database 301 from the control frame when causing a file to be downloaded or when downloading a file.

(1) File name

(2) Download originator side IP address or distribution destination IP address

(3) Timestamp of file

The distribution history list preparation/update unit 307 prepares and updates the entry of the distribution history list (change and deletion of field of entry).

The distribution history list search unit 308 searches through the distribution history list by a search key designated from the previous functional block and uses the field of a hit entry as the return value.

The distribution history list transmission unit 309 returns the distribution history list for each IP address extracted at the distribution history list search unit 308. The distribution history list search unit 308 includes also a returned distribution history list search unit of the file returned when the shutdown of a node is reversed. Further, the distribution history list transmission unit 309 includes also a returned distribution history list transmission unit of the returned file.

The control message transmission unit 310 transmits a control message concerning the management of the distribution history list database 301. The control frame includes the following two frames (for meaning of each, see next section).

(1) Distribution history list change request frame

(2) Distribution history list reception completion frame

The distribution history list transmission unit 309 transmits all entries of the distribution history list database 301.

The file search unit 311 searches for updated files from a device storing files (for example hard disk of home node).

The file transmission unit 312 searches through the distribution history list database 301 covering files found as a result of the search at the file search unit 311 and transmits the results to the distribution destination IP address. Alternatively, it transmits this toward the request originator IP address at the time of the request for return of the distribution history list.

The timer unit 313 instructs a search for updated files to the file search unit 311 at each predetermined time interval or instructs extraction of the request originator IP address of the file in which the search flag of the distribution history list becomes “1” to the distribution history list search unit 308. This is performed in order to confirm if the request originator node is restarted and the requested distribution history list can be returned.

The console unit 314 is an interface unit handling input/output of the user for presetting a punctuation holding unit and a home station IP address holding unit.

Next, the operation will be explained.

FIG. 4 is a diagram explaining the overall flow of processing for dynamically preparing the distribution route of a file according to an embodiment of the present invention. The figure shows a process where file download processing of the P2P is carried out, and the file distribution originator node α and the file distribution destination node β prepare distribution history lists.

As a prerequisite of preparing the distribution history lists, it is assumed that the search processing of a file is carried out in advance (it is assumed that there are a “query” and “hit” of FIG. 1). Namely, it is assumed here that the node β previously knows of the fact that the node α has the target file (Document A) by a method not shown here, for example, a general file search technique in the P2P.

The general processing concerning the file download in the P2P, that is, processing other than the preparation of the distribution history list, for example, the writing of the downloaded file into a disk, is performed at the P2P processing unit 305 in FIG. 5 and FIG. 6. A detailed description is omitted here.

The routine for the case where a file is further downloaded to another node from the node α or the node β is the same, so the description is omitted.

In FIG. 4, the two fields of the “request flag” and “request originator IP address” of the “distribution history list” are not used for dynamically preparing the distribution route of files, therefore the description is omitted. In the present embodiment, the distribution route of files can be dynamically formed. Namely, a download request frame is transmitted from the request originator node β to the distribution destination node α. The distribution destination node α transfers a file (Document A) to the request originator node β in response to this download request frame. It is an important point in the present embodiment that the distribution destination node be registered in the distribution history list at the distribution originator node at a point of time when a copy of the file is distributed from the distribution originator node to the distribution destination node.

Operation of Distribution Originator Node α

FIG. 5 is a diagram explaining the flow of processing in the distribution originator node α according to an embodiment of the present invention. In FIG. 5 and the following diagrams, bold line blocks are block concerned with each processing. The reception unit 303 receives a download request (for example “get” of FIG. 1) of a file from the distribution destination node β.

The P2P processing unit 305 transmits the file of the download request toward the request originator node β as a file transfer frame. When it can be transmitted without abnormality, the processing is transferred to the field extraction unit 306. At the time of an abnormality, a message is displayed in the console 314 and the processing is ended.

The field extraction unit 306 extracts the following fields from the download request frame in order to prepare the distribution history list.

(1) File name

(2) Request originator IP address of download request

Further, the update date (timestamp) of the file is extracted from the attributes of the downloaded file.

The distribution history list preparation/update unit 307 prepares a new entry in the distribution history list database 301 from the data extracted from the field extraction unit 306.

Operation of Distribution Destination Node β

FIG. 6 is a diagram explaining the flow of processing in a distribution destination node β according to an embodiment of the present invention. In the figure, the reception unit 303 receives a file for which download is requested by the home node (node β) from the node α as a file transfer frame.

The P2P processing unit 305 writes the received file into the distribution history list database 301.

The field extraction unit 306 extracts the following information from the received download file and its transfer frame.

(1) File name

(2) IP address of the download originator

(3) Updating date of the file (timestamp)

The distribution history list preparation/update unit 307 prepares a new entry in the distribution history list database 301 from the data extracted from the field extraction unit 306.

Next, the operations of the updating side node and the distribution destination node at the time of updating files will be explained.

FIG. 7 is a diagram explaining the overall flow of processing at the time of the updating files according to an embodiment of the present invention.

Summary of File Update Processing

The process where (1) a file (Document A) is updated at the node α having an original of the file and where (2) the updated file (Document A) is distributed to the node β based on the distribution history list triggered by that is shown.

As the prerequisite of the file being updated, in the present example, only the case where the file was distributed from the node α to the node β was described, but the processing in a case where the file is downloaded to a node other than the node β is also the same.

As to how the node β receiving the updated file processes the received file, for example, it may unconditionally overwrite the file before updating or confirm with the user whether to overwrite it and so on. In any case, the updated file (Document A) is written into the distribution history list of the node β.

In FIG. 7, the two fields of the “request flag” and the “request originator IP address” of the “distribution history list” are not used, therefore the description is omitted.

Next, the operations of the units in the distribution originator node and the distribution destination node at the time of updating a file will be explained.

Operation of Distribution Originator Node α

FIG. 8 is a diagram explaining the flow of processing in the distribution destination node α at the time of updating a file according to an embodiment of the present invention. In the figure, the timer unit 313 periodically drives the file search unit. The file search unit 311 searches for any file updated after the previous search from the file database 302. When detecting an updated file, it transfers the file information (file name and file per se) to the distribution history list search unit 308. When there is no updated file, it ends the processing.

The distribution history list search unit 308 searches through the distribution history list database 301 by using the file name of the file information transferred from the file search unit 311 as a key. When there is an entry of that file name, it transfers the IP address of the node of the “distribution destination IP address” and the file information transferred from the file search unit 311 to the file transmission unit 312.

The file transmission unit 312 transmits the file to the node of the “distribution destination IP address” as the updated file transfer frame.

Operation of Node β

FIG. 9 is a diagram explaining the flow of processing in the distribution destination node β at the time of updating a file according to an embodiment of the present invention. In the figure, the reception unit 303 receives the updated file transfer frame transmitted by the node α. The updated file processing unit 304 writes the file of the updated file transfer frame into the file database 302. The detailed routine of the writing method such as whether to unconditionally write the file or confirm with the user whether to write the file is not specified in the present invention.

The distribution history list search unit 308 searches for the updated file. It updates the update date to the updated date of the newly received file and, at the same time, determines whether or not the file is to be further transferred from the distribution destination IP address. Namely, it ends the processing when the field of the “distribution destination IP address” of the distribution history list is NULL and further transfers the file to the downstream node after passing through the file transmission unit 312 when the field is not NULL.

Next, the operation at the time of a request for management of the distribution history list database 301 will be explained.

FIG. 10A to FIG. 10F are diagrams explaining the overall flow of processing at the time of requesting management of the distribution history list database according to an embodiment of the present invention.

Summary of Processing at Time of Requesting

Management of Distribution History List Database 301 The process of processing for requesting retention of the distribution history list at another node (node δ in FIGS. 10A and B) by any node (node β in FIG. 10A and FIG. 10B) when this node is temporarily leaving the P2P network due to shutdown etc. of the machine is shown. FIG. 10C, FIG. 10D, FIG. 10E, and FIG. 10F show distribution history lists of the nodes α, β, γ, and δ at their timings.

Then, when the request originator node β is leaving the P2P network, if a file is received due to file updating, the request destination node δ performs processing for reception of this as a representative and the file is transmitted from the request destination node δ to the request originator node β at the time of returning the distribution history list.

As a prerequisite, it is assumed that the file is downloaded from node α→node β→node γ before the present processing starts. Further, it is assumed that the node α previously determines the other node (node δ) on the P2P network by a technique not described here (selection technique according to standard such as the adjacent node on the P2P network).

Operation of Node β: Part 1

FIG. 11 is a diagram explaining the flow of processing of (a) of FIG. 10B at the distribution destination node β at the time of requesting management of the distribution history list database according to an embodiment of the present invention. In the figure, the console unit 314 notifies the request of management of the distribution history list to another node from the console unit 314 to the distribution history list search unit 308 triggered by for example the case where the user instructs the shutdown to the node β. The distribution history list search unit 308 receiving this extracts the “distribution destination IP addresses” and “download originator IP addresses” from all entries of the distribution history list in the distribution history list database 301.

The control message transmission unit 310 transmits a distribution history list change request frame directed to both IP addresses extracted at the distribution history list search unit 308. The transmitted change request includes the following information.

(1) Change request originator IP address (node β here)

(2) Changed side IP address (node δ here)

Note that it is assumed that the “changed side IP address” is previously determined by a technique not described here (a selection technique according to a standard such as the node adjacent on the P2P network, etc.)

The distribution history list transmission unit 309 transmits the distribution history list as the distribution history list change request frame to any adjacent node (node δ here) on the P2P network which is previously determined.

Operation of Node α (true also for processing of node γ)

FIG. 12 is a diagram explaining the flow of processing of (b) of FIG. 10B at the distribution destination node α at the time of a request for management of the distribution history list database according to an embodiment of the present invention. In the figure, the reception unit 303 receives the distribution history list change request frame (transmitted by the node β).

Then, the distribution history list preparation/update unit 307 performs the following search processing two times on the distribution history list database 301 using the “change request originator IP address” included in the distribution history list change request frame as a search key.

(1) The search is carried out using the “download originator IP address” as the search target field. The “download originator IP address” of the hit entry is changed to the “changed side IP address” included in the distribution history list change request.

(2) The search is carried out using the “distribution destination IP address” as the search target field. The “distribution destination IP address” of the hit entry is changed to the “changed side IP address” included in the distribution history list change request.

Operation of Node δ

FIG. 13 is a diagram explaining the flow of processing of (c) of FIG. 10B at the distribution destination node δ at the time of a request for management of the distribution history list database according to an embodiment of the present invention. In the figure, the reception unit 303 receives the distribution history list transmission frame (transmitted by the node β). Then, the distribution history list preparation/update unit 307 writes the distribution history list of the received distribution history list transmission frame into the distribution history list database 301. Note that at this time, the following fields are added to all entries to be written.

(1) Request flag field: Written as “1”.

(2) Request originator IP address field: IP address of the transmission originator node (node β) of the distribution history list is written.

Then, the control message transmission unit 310 transmits the distribution history list reception completion frame to the transmitting side (node β) of the distribution history list.

Operation of Node δ: Part 2

FIG. 14 is a diagram explaining the flow of processing of (d) of FIG. 10B at the distribution destination node β at the time of requesting management of the distribution history list database according to an embodiment of the present invention. In the figure, the reception unit 303 receives a distribution history list reception completion frame (transmitted by the node δ). Then, the distribution history list preparation/update unit 307 deletes all entries of the distribution history list, then notifies that the processing for requesting management of the distribution history list is completed to the console 314.

Next, the operation at the time of requesting return of the distribution history list database 301 will be explained.

Summary of Processing

FIG. 15A to FIG. 15F are diagrams explaining the entire flow of processing at the time of a request for returning a distribution history list database according to an embodiment of the present invention. In the figure, when any node (node β in FIG. 15A and FIG. 15B) temporarily leaves the P2P network for the reason of a machine shutdown or the like, it requests the retention of the distribution history list to another node (node δ in FIG. 15A), then, when the reason for the request originator node (node β) temporarily leaving the P2P network is eliminated, the node returns again to the P2P network and has its own distribution history list returned from the requested side (node δ).

As a prerequisite, in the same way as the cases of FIG. 10A to FIG. 10F, it is assumed that the file is downloaded from node α→node β→node γ before the present processing starts. Further, it is assumed that the node α previously determines the other node (node δ) on the P2P network by a technique not described here (a selection technique according to a standard such as the adjacent node on the P2P network, etc.). Note that FIG. 15C, FIG. 15D, FIG. 15E, and FIG. 15F show the distribution history lists of the node α, node β, node γ, and node δ at this time.

Operation of Node δ: Part 1

FIG. 16 is a diagram explaining the flow of processing of (a) of FIG. 15B at the distribution destination node δ at the time of a request for returning a distribution history list database according to an embodiment of the present invention. In the figure, the timer unit 313 periodically drives a search of entries in which the “request flag field” is “1” for the distribution history list search unit 308.

The distribution history list search unit 308 receiving the drive operation from the timer unit 313 executes the search for entries in which the “request flag field” is “1” for the distribution history list database 301. For each “request originator IP address field” of the corresponding entry, the fields except for the “request flag field” and the “request originator IP address field” of the entry are transferred to the distribution history list transmission unit. Note that, when a file in the distribution history list which begins to be managed as representative is updated during the representative management by the routine of the request for management of the distribution history list database 301 described with reference to FIG. 10 to FIG. 14, that file is also transferred to the distribution history list transmission unit 309 (not shown).

The distribution history list transmission unit 309 also transmits the entry and file (if updated) of the distribution history list transferred from the distribution history list search unit 308 as the distribution history list transmission frame using the request originator IP address as the distribution destination address.

Operation of Node β

FIG. 17 is a diagram explaining the flow of processing of (b) of FIG. 15B at the distribution destination node β at the time of the request for returning the distribution history list database according to an embodiment of the present invention. The distribution history list preparation/update unit 307 prepares the entry (restores the entry) for the distribution history list database 301 from the distribution history list transmission frame. If that file is included in the distribution history list transmission frame, the file of the file database 302 is also updated (not shown).

The control message transmission unit 310 transmits the following two control messages.

(1) Distribution history list reception completion frame: Transmitted to the transmitting side (node δ) of the distribution history list transmission frame.

(2) Distribution history list change request frame: Transmitted for each download originator IP address (IP-α) and distribution destination IP address (IP-γ) of the restored entry. The distribution history list change request frame includes also the transmission originator IP address (IP-β) of the distribution history list transmission frame.

Operation of Node δ: Part 2

FIG. 18 is a diagram explaining the flow of processing of (c) of FIG. 15B at the distribution destination node δ at the time of the request for returning the distribution history list database according to an embodiment of the present invention. In the figure, the reception unit 303 receives the distribution history list reception completion frame. Note that, after transmitting the distribution history list transmission frame, if the frame is not received within a constant time, the operation ends by the time for reception running out. This is because it is judged that the request originator IP address still exists in a state where the distribution history list cannot be remanaged.

The distribution history list transmission unit 309 searches for the “request originator IP address field” of the distribution history list database 301 using the transmission originator IP address (IP-β) of the distribution history list reception completion frame as the search key and deletes the corresponding entry.

Operation of Node α

FIG. 19 is a diagram explaining the flow of processing of (d) of FIG. 15B at the distribution destination node α at the time of the request for returning the distribution history list database according to the embodiment of the present invention. In the figure, the reception unit 303 receives the distribution history list change request frame. The distribution history list preparation/update unit 307 performs the following search processing two times on the distribution history list DB using the IP address (IP-δ) included in the distribution history list change request frame as a search key.

(1) The search is carried out by using the “download originator IP address” as the search target field. The “download originator IP address” of the hit entry is changed to the transmission originator IP address (IP-β) of the distribution history list change request frame.

(2) The search is carried out by using the “distribution destination IP address” as the search target field. The “distribution destination IP address” of the hit entry is changed to the transmission originator IP address (IP-δ) of the distribution history list change request frame.

### INDUSTRIAL APPLICABILITY

As clear from the above explanation, according to the present invention, management of the distribution routes of files by nodes in the P2P network enables the re-distribution of updated files and a reduction in the number of steps of a file search of a user by that.

Further, even when a certain node shuts down in the P2P network, by preparing a file distribution route by a representative node, even when a node on the file distribution route shuts down, the updated file can be resent, and thus the real time property of the distribution of the updated file is improved.

1. A file management system characterized in that at least one of the nodes included in a peer-to-peer type network is provided with a database storing updateable files and a distribution history list preparing means for preparing a distribution history list storing distribution destination nodes of files stored in the database.

2. A file management system as set forth in claim 1, wherein said at least one node is provided with a file re-distributing means for distributing an updated file to the distribution destination nodes registered in the distribution history list in a predetermined time from the updating when a file is updated.

3. A file management system as set forth in claim 2, wherein all nodes included in the peer-to-peer type network are provided with distribution history list preparing means and file re-distributing means.

4. A file management system as set forth in claim 3, wherein provision is made of a distribution history list ensuring means for ensuring the distribution history list to a representative node included in the peer-to-peer type network different from the distribution originator node in a case where the distribution originator node of the file leaves the peer-to-peer type network.

5. A file management system as set forth in claim 4, wherein said representative node is provided with a file returning means for returning the distribution history list from the representative node to the returning node in a case where a node leaving the peer-to-peer type network returns to the peer-to-peer type network.

6. A file management method characterized by being provided with a step of storing updateable files in a database and a step of preparing a distribution history list storing distribution destination nodes of the updateable files in at least one node included in a peer-to-peer type network.

7. A file management method as set forth in claim 6, further provided with a step of distributing an updated file to the distribution destination nodes registered in said distribution history list in a predetermined time from the updating when a file is updated in at least one node.

8. A file management method as set forth in claim 7, further provided with a step of preparing said distribution history list and a step of distributing an updated file to said distribution destination nodes registered in said distribution history list within a predetermined time from updating in all nodes included in said peer-to-peer type network.

9. A file management method as set forth in claim 8, further provided with a step of entrusting said distribution history list to a representative node included in said peer-to-peer type network different from said distribution originator node in the case where the distribution originator node of said file leaves said peer-to-peer type network.

10. A file management method as set forth in claim 9, further provided with a step of returning said distribution history list from said representative node to the returning node in a case where a node leaving said peer-to-peer type network returns to said peer-to-peer type network.

11. A file management program for making a computer execute a step of storing updateable files in a database and a step of preparing a distribution history list storing distribution destination nodes of the updateable files in at least one node included in a peer-to-peer type network.

12. A file management program as set forth in claim 11 for making the computer further execute a step of distributing an updated file to the distribution destination nodes registered in said distribution history list in a predetermined time from the updating when a file is updated in at least one node.

13. A file management program as set forth in claim 12 for making the computer further execute a step of preparing said distribution history list and a step of distributing an updated file to said distribution destination nodes registered in said distribution history list within a predetermined time from updating in all nodes included in said peer-to-peer type network.

14. A file management program as set forth in claim 13 for making the computer further execute a step of entrusting said distribution history list to a representative node included in said peer-to-peer type network different from said distribution originator node in the case where the distribution originator node of said file leaves said peer-to-peer type network.

15. A file management program as set forth in claim 14 for making the computer further execute a step of returning said distribution history list from said representative node to the returning node in a case where a node leaving said peer-to-peer type network returns to said peer-to-peer type network.

16. A computer readable storage medium storing a file management program for making a computer execute a step of storing updateable files in a database and a step of preparing a distribution history list storing distribution destination nodes of the updateable files in at least one node included in a peer-to-peer type network.

17. A computer readable storage medium storing a file management program as set forth in claim 16 for making the computer further execute a step of distributing an updated file to the distribution destination nodes registered in said distribution history list in a predetermined time from the updating when a file is updated in at least one node.

18. A computer readable storage medium storing a file management program as set forth in claim 17 for making the computer further execute a step of preparing said distribution history list and a step of distributing an updated file to said distribution destination nodes registered in said distribution history list within a predetermined time from updating in all nodes included in said peer-to-peer type network.

19. A computer readable storage medium storing a file management program as set forth in claim 18 for making the computer further execute a step of entrusting said distribution history list to a representative node included in said peer-to-peer type network different from said distribution originator node in the case where the distribution originator node of said file leaves said peer-to-peer type network.

20. A computer readable storage medium storing a file management program as set forth in claim 18 for making the computer further execute a step of returning said distribution history list from said representative node to the returning node in a case where a node leaving said peer-to-peer type network returns to said peer-to-peer type network.
